(19) United States
(12) Patent Application Publication
(10) Pub. No.: US 2026/0123767 A1
(43) Pub. Date: May 7, 2026

(54) PARTITIONED FOAM CORE AND FOAM MATTRESS

(71) Applicant: Guangdong Sweetnight Technical Innovation Co., Ltd., Guangzhou (CN)

(72) Inventors: Shuimu HUANG, Foshan (CN); Eason CHEN, Guangzhou (CN); Runlan REN, Huizhou (CN); Liang CHEN, Guangzhou (CN); Qinghuang ZENG, Guangzhou (CN)

(21) Appl. No.: 18/937,633

(22) Filed: Nov. 5, 2024

(51) Int. Cl. A47C 27/15; A47C 27/14; A47C 27/16; B32B 3/30; B32B 5/18

(52) U.S. Cl. CPC A47C 27/15; A47C 27/144; A47C 27/16; B32B 3/30; B32B 5/18

(57) ABSTRACT

A foam mattress is disclosed. The foam mattress includes a first foam layer and a second foam layer. A top surface of the second foam layer is in contact with a bottom surface of the first foam layer. The top surface of the second foam layer is formed with a first ridged pattern having a first plurality of ridges. The first ridged pattern has a first dimension between two ridges of the first plurality of ridges and a second dimension at a bottom of between ridges of the first plurality of ridges, wherein a firmness of the mattress is dependent on a ratio of the first dimension and the second dimension.

### BACKGROUND

### 1. Field

The present disclosure is directed to foam mattresses, and more particularly, foam mattresses with multiple layers.

### 2. Description of Related Art

Foam mattresses are often times used as an alternative to spring mattresses. Many of these foam mattresses are partitioned into multiple layers. These layers serve different purposes to enhance various aspects of the mattress performance, such as its support, its comfort, and its durability.

A top layer (i.e., the layer upon which a person lies) may be referred to as a comfort layer. The comfort layer may comprise various materials such as memory foam, gel-infused foam, or other soft materials. This layer may provide a cushioned feel for a person lying there upon, and may contour to the person's body. The comfort layer may also provide pressure relief.

A transition layer may be disposed immediately under the comfort layer. This layer may provide a transition from the softness of the comfort layer to one or more layers underneath that provide support for the body weight of the person lying on the comfort layer. Higher density foam, which may provide additional support, may be used in making the transition layer.

A support core provides foundational support for the mattress, being disposed underneath the transition layer. This layer is comprised of high-density foam, and provide the primary support for the mattress. In providing this support, the support core ensures the durability of the mattress and its ability to maintain its shape over time. Some mattresses may also include a base layer underneath the support core for additional stability and support.

### SUMMARY

Various embodiments of a foam mattress are disclosed. In one embodiment, a foam mattress includes a first foam layer and a second foam layer. A top surface of the second foam layer is in contact with a bottom surface of the first foam layer. The top surface of the second foam layer is formed with a first ridged pattern having a first plurality of ridges. The first ridged pattern has a first dimension between two ridges of the first plurality of ridges, and a second dimension in a trough (or bottom) between ridges of the first plurality of ridges. A firmness of the mattress is dependent on a ratio of the first dimension and the second dimension.

In one embodiment, a first instance of the mattress in which the second dimension is greater than the first dimension has a greater firmness than a second instance of the mattress in which the first dimension is greater than the second dimension.

In various embodiments, the firmness may further depend on vertical dimensions of the ridges. Ones of the plurality of ridges have a first height from a trough between ones of the plurality of ridges to a top of ones of the plurality of ridges, and a second height between the trough of between ones of the plurality of ridges and a bottom surface of the respective foam layer. The firmness of the mattress is further dependent on a ratio of the first height to the second height.

Embodiments with more than two foam layers are also possible and contemplated. One or more of the additional foam layers may also include ridged patterns on their respective top surfaces. With regard to the bottom surfaces of various ones of the layers, the surfaces may either be substantially flat or may have a ridged pattern that is complementary to and conforms with that of the layer beneath it.

### BRIEF DESCRIPTION OF THE DRAWINGS

The above and/or other aspects will become apparent and more readily appreciated from the following description of example embodiments, taken in conjunction with the accompanying drawings, in which:

FIG. 1 is a perspective view of one embodiment of a foam mattress in accordance with the disclosure.

FIGS. 2A and 2B illustrate side views of ridge patterns that may be cut into a layer of a foam mattress in accordance with the disclosure.

FIGS. 3A and 3B illustrate side views of foam layers of a mattress having complementary and conformal ridge patterns.

FIGS. 4A and 4B illustrate side views of mattresses having multiple layers with different ridge patterns.

FIGS. 5A and 5B illustrate side views of mattresses having multiple layers with different ridge patterns and filling bodies disposed between selected ones of the ridges.

FIG. 6 is a flow diagram illustrating a method for manufacturing a foam mattress according to the disclosure.

### DETAILED DESCRIPTION

Foam mattresses are typically divided into two or more layered sections that may be placed on top of one another. These different foam layers may have varying degrees of firmness to meet the overall desired firmness of the mattress. The layers may be cut from foam using ordinary cutting technology. The foam layers of a given mattress may have different levels of firmness, and may be bonded to other foam layers to complete the mattress.

Typical foam mattresses may be cut flat at the layer boundaries that bond the various foam layers to one another. This may increase the difficulty in controlling the desired firmness, thereby having an undesired impact on the comfort of the finished mattress. Furthermore, segmented bonding of this type of mattress may risk separation between two otherwise bonded layers. Weight and materials waste may also occur during the manufacturing of these types of foam mattresses.

The foam mattress of the present disclosure may overcome these issues, resulting in a mattress that can be manufactured using less material and/or at a lower weight, while providing better control of the overall firmness to achieve a desired level of comfort.

A foam core mattress according to the disclosure may be made using multiple foam layers, with special cutting shapes on the surfaces that are in contact with other foam layers. In various embodiments, the cutting patterns on the surfaces of at least some of the layers may comprise a ridge-shaped pattern having a plurality of ridges. Through control of the shape and dimensions of the ridges, the firmness of a given instance of a mattress according to the disclosure may be more precisely controlled. Various embodiments of a foam mattress according to the disclosure are now discussed in further detail.

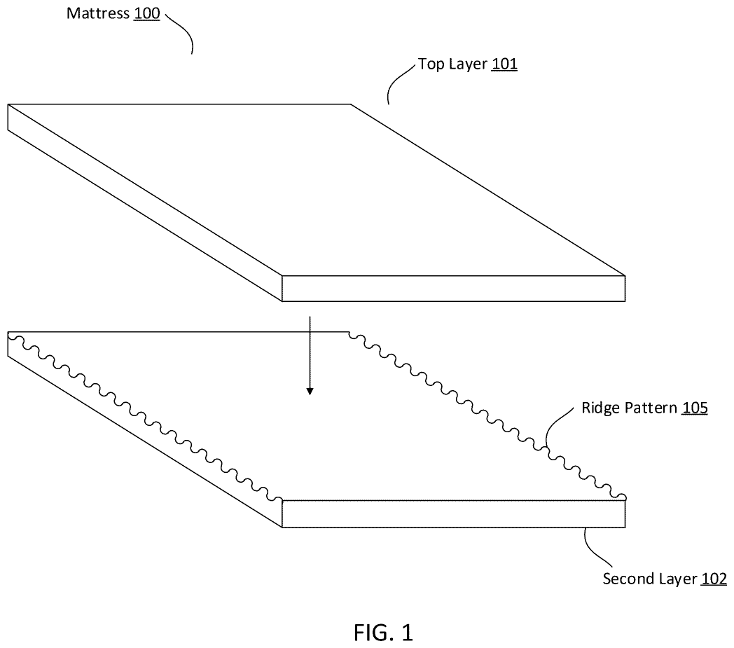

FIG. 1 is a perspective view of one embodiment of a foam mattress in accordance with the disclosure. In the example shown, mattress 100 includes a top layer 101 and a second layer 102. Both top layer 101 and second layer 102 may be made of a foam material. In some embodiments, additional foam layers may also be present, although embodiments of a mattress using only the two layers shown are also possible and contemplated. The sizes of the layers may be used to form mattress 100 in any one of a number of different standard bed sized (e.g., king size, queen size, etc.), or of any other desired size, including custom sizes.

As defined herein, a top layer of the mattress is a layer upon which, e.g., a person lies on the mattress. Furthermore, as defined herein, the term “top” with respect to a surface of a given foam layer is the surface of that layer closest to the top layer. Similarly, the term “bottom” with respect to a surface of a foam layer is the surface thereof furthest from the top layer. The disclosure further contemplates double-sided mattresses, wherein either of the two largest sides can serve as the top side or bottom side.

Second layer 102 in the illustrated example is cut with a ridged pattern 105 on its top surface. This ridged pattern 105 may include a number of ridges that extend across second layer 102. As will be discussed in additional detail below, various dimensions of these ridges may affect the overall firmness of mattress 100. Accordingly, these dimensions may be adjusted during the manufacturing process in order to fabricate instances of the mattress at desired firmness levels.

In some implementations, a bottom surface of top layer 101 may include a ridged pattern that is the same or similar to that of ridge pattern 105. Accordingly, the ridged patterns on these layers may be complementary and conformal to one another when top layer 101 and second layer 102 are in contact with one another in the final mattress product. However, embodiments in which the bottom surface of top layer 102 is substantially flat are also possible and contemplated.

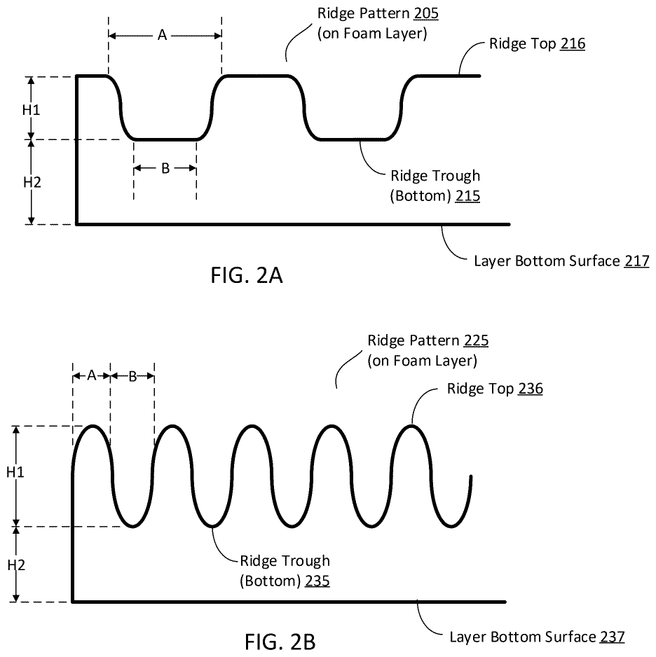

FIGS. 2A and 2B illustrate side views of ridge patterns that may be cut into a layer of a foam mattress in accordance with the disclosure. In FIG. 2A, a ridge pattern 205 that may be cut into a layer of a foam mattress is substantially flat on the ridge tops 216 as well as on the ridge trough (or bottom) 215.

Various dimensions associated with the ridge pattern 205 (and thus the foam layer into which it is cut) may affect the firmness of the overall finished mattress. In this example, the dimension H1 is the height of each ridge, from an adjacent ridge trough 215 to a ridge top 216. The dimension H2 as shown here is the distance between a ridge trough 215 and the bottom surface 217 of the mattress layer. These dimensions, and the ratio of one to another, may affect the overall firmness of the finished mattress. For example, in the case in which H1 is greater than H2, the larger the ratio of H1 to H2, the softer the finished mattress will be. When H2 is greater than H1, a larger ratio of H2 to H1 will result in a firmer finished mattress.

The dimensions A and B may also affect the firmness of the finished mattress. The dimension A in FIG. 2A spans between the end of one ridge top 216 and the beginning of the next ridge top 216. The dimension B spans the distance of the flat portion of ridge trough 215. In the case where A is greater than B, larger values of A will result in a softer finished product. In the case where B is greater than A, larger values of B will result in a firmer finished product.

Accordingly, a foam mattress according to the present disclosure may be manufactured according to a desired firmness by controlling the dimensions H1, H2, A, and B. Furthermore, having controllable dimensions (H1 and H2) along a vertical access and controllable dimensions (A and B) along a horizontal access may allow for a high degree of fine-tuning the desired firmness and/or weight of a foam mattress in accordance with the disclosure.

FIG. 2B illustrates another example of a ridge pattern. In this example, ridge pattern 225 is substantially sinusoidal in shape. Similar to the embodiment discussed above with reference to FIG. 2A, a dimension H1 is defined as a distance between a ridge trough 235 and a ridge top 236. Dimension H2 is defined as a distance between a ridge trough 235 and layer bottom surface 237. Dimensions A and B as shown here are centered around ridge top 236 and a ridge bottom 235, respectively. The shape of the sinusoidal ridge pattern is adjustable to achieve desired values of H1, H2, A, and B to obtain a corresponding level of firmness in the mattress. Moreover, the firmness of the mattress may adjusted by changing these dimensions in largely the same manner as that described above with reference to FIG. 2A.

It is noted that FIGS. 2A and 2B are provided here by way of example, but are not intended to be limiting the respective shapes of ridges and ridge patterns that are possible according to the disclosure. On the contrary, a wide variety of ridge patterns/shapes (e.g., sawtooth, square wave, etc.) are possible and contemplated by the present disclosure. The various shapes may each be defined at least in part by the dimensions A, B, H1 and H2 as discussed above, and adjustments to these dimensions may be carried out during the design and/or manufacturing process to obtain a desired firmness and/or weight of the finished mattress product.

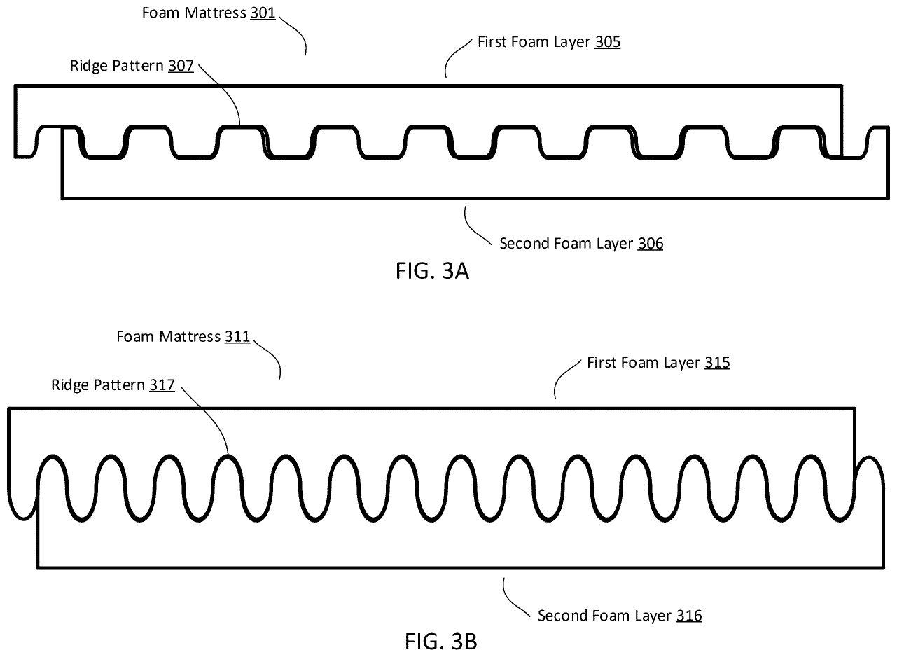

FIGS. 3A and 3B illustrate side views of foam layers of a mattress having complementary and conformal ridge patterns. In FIG. 3A, foam mattress 301 includes a first foam layer 305 and a second foam layer 306 each having a ridge pattern 307. When these two layers are placed together in the manner shown, the ridge patterns are conformal and complementary to one another. That is, the matching of the ridge pattern 307 on each of first foam layer 305 and second foam layer 306 may thus allow these layers to be assembled into a mattress with minimal space there between. FIG. 3B illustrates a similar arrangement, with foam mattress 311 including a first foam layer 315 and a second foam layer 316 each having a sinusoidal shaped ridge pattern 317. In various embodiments of a mattress according to the disclosure, at least some layers may be cut with complementary and conformal ridge patterns such that they may be placed adjacent to one another in the manner shown here. However, as will be discussed below, the various foam layers of a given mattress embodiment need not have complementary ridge patterns.

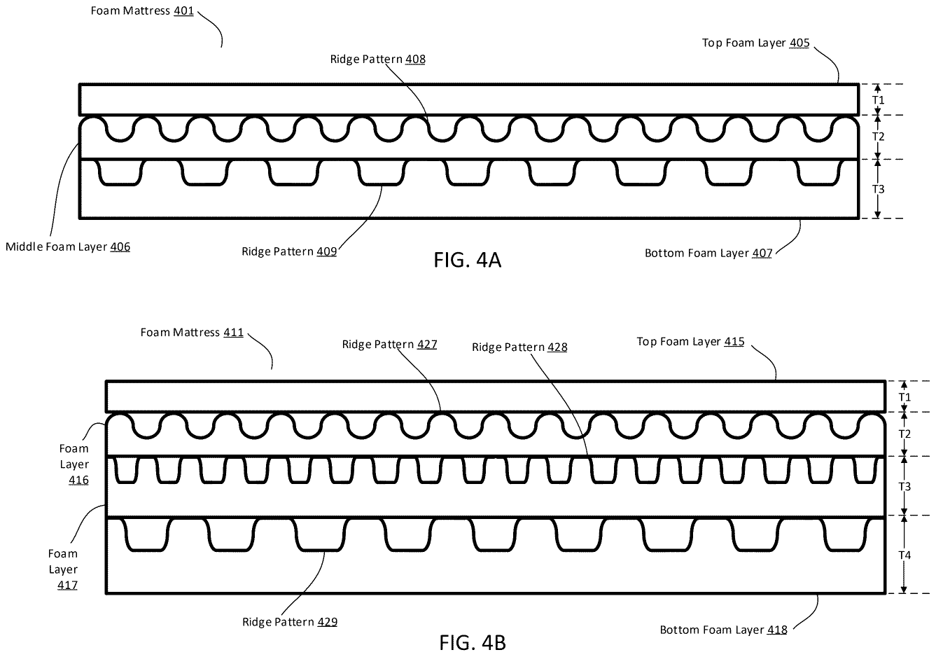

FIGS. 4A and 4B illustrate side views of mattresses having multiple layers with different ridge patterns. Foam mattress 401 of FIG. 4A includes three foam layers—top foam layer 405, middle foam layer 406, and bottom foam layer 407, which have thicknesses of T1, T2, and T3, respectively. Each of the foam layers shown here has a flat bottom surface. Middle foam layer 406 has a ridge pattern 408, while bottom foam layer 407 has a different ridge pattern 409. The firmness of foam mattress 401 may be determined at least in part by the dimensions H1, H2, A, and B for ridge patterns 408 and 409. Having two different layers with ridge patterns as shown here may allow for further fine-tuning of the desired firmness and/or weight of foam mattress 401.

Foam mattress 411 of FIG. 4B includes four foam layers—top foam layer 415, foam layer 416, foam layer 417, and bottom foam layer 418, which have thicknesses T1, T2, T3, and T4, respectively. These layers may be respectively referred to as a comfort layer, a support core, and a base layer. To foam layer 416 is cut with a ridge pattern 427, foam layer 417 is cut with a ridge pattern 428, and bottom foam layer 418 is cut with ridge pattern 429. Each of these ridge patterns are different from one another, with their own unique values of the dimensions H1, H2, A, and B. Accordingly, additional, fine-tuning of the overall mattress firmness and/or weight may be carried out based on these dimensions.

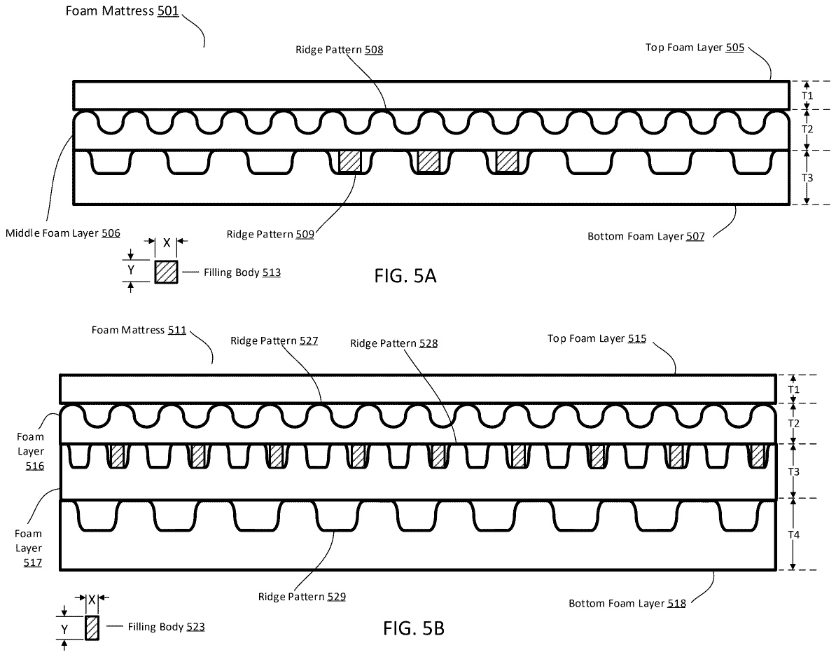

FIGS. 5A and 5B illustrate respective side views of mattresses having multiple layers with different ridge patterns and filling bodies disposed between selected ones of the ridges. Foam mattress 501 of FIG. 5A includes a top foam layer 505, a middle foam layer 506, and a bottom foam layer 507, the layers having thicknesses of T1, T2, and T3, respectively. Middle foam layer 506 is formed with a ridge pattern 508, while bottom foam layer 507 is formed with a ridge pattern 509.

Additionally, foam mattress 501 in the illustrated example includes a number of filling bodies 513 that are disposed in the spaces defined by the troughs of ridge pattern 509. These filling bodies 513 may be made of a soft material that may be compressed when weight is placed on foam mattress 501. Embodiments that use other materials (e.g., hard sponge) are also possible and contemplated. In some embodiments, the material used to make filling bodies 513 may be the same foam material used in the various foam layers of mattress 501. Other materials, such as cotton, may also be used in various embodiments. The filling bodies 513 may each, in some embodiments, have a horizontal dimension X and a vertical dimension Y. Adjusting these dimensions of filling bodies 513 may in turn alter their firmness. Thus, through adjustments of their respective dimensions and placement, filling bodies 513 may provide an additional adjustment to the firmness of the mattress 501 overall.

Foam mattress 511 of FIG. 5B includes four layers, top layers 515, foam layer 516, foam layer 517, and bottom foam layer 518, with respective thicknesses of T1, T2, T3, and T4. Foam layer 516 is formed with ridge pattern 527, foam layer 517 is formed with a ridge pattern 528, and bottom foam layer 518 is formed with a ridge pattern 529. Additionally, foam mattress 511 also includes a number of filling bodies selectively disposed in the spaces left by ridge pattern 528. Similar to the embodiment above, filling bodies 523 have an X dimension and a Y dimension that is adjustable from one embodiment to the next, and are made of a soft material. Along with the other dimensional adjustments discussed above, the placement and dimensions of instances of filling body 523 may be adjusted to further fine-tune the firmness and/or weight of foam mattress 511.

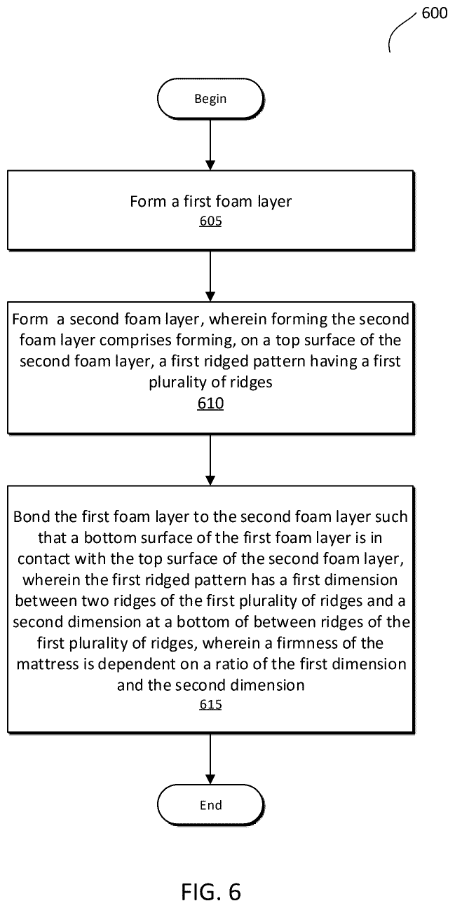

FIG. 6 is a flow diagram illustrating a method for manufacturing a foam mattress according to the disclosure. Method 600 as discussed herein may be used to manufacture any of the various embodiments of a mattress according to the disclosure.

Method 600 includes forming a first foam layer (block 605) and forming a second foam layer (block 610). Forming the second foam layer comprises forming, on a top surface of the second foam layer, a first ridged pattern having a first plurality of ridges. Method 600 further includes bonding the first foam layer to the second foam layer such that a bottom surface of the first foam layer is in contact with the top surface of the second foam layer (block 615). Any suitable bonding technique (e.g., such as the application of adhesives) may be used to bond the first foam layer to the second foam layer. Furthermore, the first ridged pattern has a first dimension between two ridges of the first plurality of ridges and a second dimension at a bottom of between ridges of the first plurality of ridges, wherein a firmness of the mattress is dependent on a ratio of the first dimension and the second dimension.

In various implementations, the method includes manufacturing a first instance of the mattress in which the second dimension is greater than the first dimension and manufacturing a second instance of the mattress in which the first dimension is greater than the second dimension. The firmness of the first instance of the mattress is greater than the firmness of the second instance of the mattress based on respective and relative values of the first and second dimensions.

Embodiments of the method may further includes forming the second foam layer such that ones of the plurality of ridges have a first height from a trough between ones of the plurality of ridges to a top of ones of the plurality of ridges, and a second height between the trough of between ones of the plurality of ridges and a bottom surface of the second foam layer, and wherein the firmness of the mattress is further dependent on a ratio of the first height to the second height.

In some embodiments, the method includes forming a bottom surface of the first foam layer such that the top surface of the second foam layer conforms to and is complementary with the first ridged pattern as formed on the bottom surface of the first foam layer.

The method may further include forming the first ridged pattern such that a top portion of ones of the first plurality of ridges is flat and a bottom portion between the ones of the first plurality of ridges is flat, and wherein a dimension of the top portion is equal to a dimension of the bottom portion. Another embodiment of the method may include forming the first ridged pattern to be sinusoidal in shape.

In one embodiment, the method includes forming a third foam layer, wherein forming the third foam layer comprises forming a top surface of the third foam layer with a second ridged pattern having a second plurality of ridges and bonding the top surface of the third foam layer to a bottom surface of the second foam layer. Various embodiments may include disposing one or more filling bodies between selected ones of the second plurality of ridges. Some embodiments of the method may also include forming a fourth foam layer and bonding a top surface of the fourth foam layer to a bottom surface of the third foam layer.

It will be understood that the terms “include,” “including,” “comprise,” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list.

Various terms are used to refer to particular system components. Different companies may refer to a component by different names—this document does not intend to distinguish between components that differ in name but not function.

Matters of these example embodiments that are obvious to those of ordinary skill in the technical field to which these example embodiments pertain may not be described herein in detail.

It may be understood that the example embodiments described herein may be considered in a descriptive sense only and not for purposes of limitation. Descriptions of features or aspects within each example embodiment may be considered as available for other similar features or aspects in other example embodiments.

While example embodiments have been described with reference to the figures, it will be understood by those of ordinary skill in the art that various changes in form and details may be made therein without departing from the spirit and scope as defined by the following claims.

What is claimed is:

1. A mattress comprising:
a first foam layer; and
a second foam layer, wherein a top surface of the second foam layer is in contact with a bottom surface of the first foam layer, and wherein the top surface of the second foam layer is formed with a first ridged pattern having a first plurality of ridges;
wherein the first ridged pattern has a first dimension between two ridges of the first plurality of ridges and a second dimension at a bottom of between ridges of the first plurality of ridges, wherein a firmness of the mattress is dependent on a ratio of the first dimension and the second dimension.

2. The mattress of claim 1, wherein a first instance of the mattress in which the second dimension is greater than the first dimension has a greater firmness than a second instance of the mattress in which the first dimension is greater than the second dimension.

3. The mattress of claim 1, wherein ones of the plurality of ridges have a first height from a trough between ones of the plurality of ridges to a top of ones of the plurality of ridges, and a second height between the trough of between ones of the plurality of ridges and a bottom surface of the second foam layer, and wherein the firmness of the mattress is further dependent on a ratio of the first height to the second height.

4. The mattress of claim 3, wherein a first instance of the mattress in which the second height is greater than the first height has a greater firmness than a second instance of the mattress in which the first height is greater than the second height.

5. The mattress of claim 1, wherein the bottom surface of the first foam layer is formed having the first ridged pattern such that the top surface of the second foam layer conforms to and is complementary with the first ridged pattern as formed on the bottom surface of the first foam layer.

6. The mattress of claim 1, wherein a top portion of ones of the first plurality of ridges is flat, and wherein a bottom portion between the ones of the first plurality of ridges is flat, and wherein a dimension of the top portion is equal to a dimension of the bottom portion.

7. The mattress of claim 1, wherein the first ridged pattern is sinusoidal in shape.

8. The mattress of claim 1, further comprising a third foam layer, wherein a top surface of the third foam layer is in contact with a bottom surface of the second foam layer, wherein the top surface of the third foam layer is formed with a second ridged pattern having a second plurality of ridges.

9. The mattress of claim 8, further comprising a fourth foam layer, wherein a top surface of the fourth foam layer is in contact with a bottom surface of the third foam layer.

10. The mattress of claim 8, further comprising a plurality of filling bodies, wherein ones of the filling bodies are disposed between selected ones of the second plurality of ridges.

11. A method for manufacturing a mattress, the method comprising:
forming a first foam layer;
forming a second foam layer, wherein forming the second foam layer comprises forming, on a top surface of the second foam layer, a first ridged pattern having a first plurality of ridges; and
bonding the first foam layer to the second foam layer such that a bottom surface of the first foam layer is in contact with the top surface of the second foam layer;
wherein the first ridged pattern has a first dimension between two ridges of the first plurality of ridges and a second dimension at a bottom of between ridges of the first plurality of ridges, wherein a firmness of the mattress is dependent on a ratio of the first dimension and the second dimension.

12. The method of claim 11, further comprising:
manufacturing a first instance of the mattress in which the second dimension is greater than the first dimension; and
manufacturing a second instance of the mattress in which the first dimension is greater than the second dimension;
wherein the firmness of the first instance of the mattress is greater than the firmness of the second instance of the mattress based on respective and relative values of the first and second dimensions.

13. The method of claim 11, further comprising:
forming the second foam layer such that ones of the plurality of ridges have a first height from a trough between ones of the plurality of ridges to a top of ones of the plurality of ridges, and a second height between the trough of between ones of the plurality of ridges and a bottom surface of the second foam layer, and wherein the firmness of the mattress is further dependent on a ratio of the first height to the second height.

14. The method of claim 11, further comprising forming a bottom surface of the first foam layer such that the top surface of the second foam layer conforms to and is complementary with the first ridged pattern as formed on the bottom surface of the first foam layer.

15. The method of claim 11, further comprising forming the first ridged pattern such that a top portion of ones of the first plurality of ridges is flat and a bottom portion between the ones of the first plurality of ridges is flat, and wherein a dimension of the top portion is equal to a dimension of the bottom portion.

16. The method of claim 11, further comprising forming the first ridged pattern to be sinusoidal in shape.

17. The method of claim 11, further comprising:
forming a third foam layer, wherein forming the third foam layer comprises forming a top surface of the third foam layer with a second ridged pattern having a second plurality of ridges; and
bonding the top surface of the third foam layer to a bottom surface of the second foam layer.

18. The method of claim 17, further comprising disposing one or more filling bodies between selected ones of the second plurality of ridges.

19. The method of claim 17, further comprising:
forming a fourth foam layer; and
bonding a top surface of the fourth foam layer to a bottom surface of the third foam layer.

20. A foam mattress comprising:
a first foam layer;
a second foam layer, wherein a top surface of the second foam layer is formed having a first ridged pattern having a first plurality of ridges, wherein the first ridged pattern has a first dimension between two ridges of the first plurality of ridges and a second dimension at a bottom of between ridges of the first plurality of ridges, wherein the top surface of the second foam layer is in contact with a bottom surface of the first foam layer; and
a third foam layer, wherein a top surface of the third foam layer is in contact with a bottom surface of the second foam layer, and wherein the top surface of the third foam layer is formed having a second ridged pattern having a second plurality of ridges;
wherein a firmness of the foam mattress is dependent on a ratio of the first dimension and the second dimension; and
wherein ones of the plurality of ridges have a first height from a trough between ones of the plurality of ridges to a top of ones of the plurality of ridges, and a second height between the trough of between ones of the plurality of ridges and a bottom surface of the second foam layer, and wherein the firmness of the mattress is further dependent on a ratio of the first height to the second height.
